(19) United States
(12) Patent Application Publication
(10) Pub. No.: US 2013/0209061 A1
(43) Pub. Date: Aug. 15, 2013

(54) MULTIMEDIA PLAYING CONTROL METHOD, PLAYING CONTROL MODULE AND PLAYING TERMINAL

(71) Applicant: Yinong LIU, Beijing (CN)

(72) Inventor: Yinong LIU, Beijing (CN)

(73) Assignee: SONY MOBILE COMMUNICATIONS AB, Lund (SE)

(21) Appl. No.: 13/484,305

(22) Filed: May 31, 2012

(30) Foreign Application Priority Data
Feb. 14, 2012 (CN) 201210033123.6

(51) Int. Cl. H04N 9/80

(52) U.S. Cl. 386/241; 348/E09.011

(57) ABSTRACT

The present invention provides a multimedia playing control method, playing control module and playing terminal. The method comprises: detecting a position indicated by a user on a speed bar displaying a playing speed of a multimedia file; and amplifying and displaying the time period to which the position corresponds by a predetermined amplifying parameter, such that the user selects a playing moment according to the amplified and displayed time period. With the embodiments of the present invention, a playing speed may be precisely allocated to a desired position, without being affected by the size of the display screen of the playing terminal, the size and playing time of the played multimedia file, the size of the speed bar, and the playing mode, and solve the technical problems existed in the prior art.

### TECHNICAL FIELD

The present invention relates to multimedia playing technologies, and in particular to a multimedia playing control method, playing control module and playing terminal.

### BACKGROUND ART

Currently, in the course of watching video or listening to audio programs (sometimes for convenience individually and collectively referred to below as content, multimedia content or a multimedia file, and so on) via a playing terminal, e.g., a TV set, an MP4 player, a mobile phone, a computer, etc., if the user wants to skip over unwanted content in the video or audio programs or wants to watch or listen to content that he has watched or listened to before from a desired moment, the user usually may use a mouse, a key, or a touch screen, etc. to control the playing speed of the multimedia content via the speed bar, which indicates the playing speed on the displaying interface, e.g., on a displaying screen of the playing terminal.

FIGS. 1A and 1B are schematic diagrams showing prior art speed allocation or determination or identification of speed of played video content. As shown in FIGS. 1A and 1B, the video content is played on a playing terminal 100, such as on the displaying screen 101 of the playing terminal. For example, the displaying screen 101 may be a touch sensitive screen of a playing terminal in the form of a mobile phone. As an example, total playing time of the video program is 01:30:00 (1 hour, 30 minutes and 00 second), as is represented by the length of the speed bar 102 in FIGS. 1A and 1B. A normal speed allocation or determination process is as follows. As shown in FIG. 1A, the entire video content file is represented by the speed bar 102. The video content currently being played is the content to which the icon or indicator T1 corresponds. Movement or motion of the icon T1 along the speed bar 102 is representative of the speed at which the video content (or multimedia file, etc.) is being played. Typically the icon T1 may move automatically along the speed bar 102 as the video content is played to allocate, determine or indicate the location along the extent of the video content (or video file) that currently is being played. The icon T1 moment, as illustrated, for example, corresponds to a moment or time 00:10:00 in the course of playing the video content. If the user of the playing terminal wants to skip over the content between the T1 moment and a T2 moment, e.g., the T2 moment being (00:20:00) in the course of the video content represented along the speed bar 102, he may select the position to which the T2 moment corresponds by a key of the playing terminal or by touch with a finger on the touch sensitive displaying screen 101, etc. In this way, the playing terminal may skip over the content between T1 and T2 and starts to play the video content from the position to which the T2 moment corresponds.

### SUMMARY OF THE INVENTION

The following problems exist in the above prior art playing control method. For example, one or more of the size of the display screen 101 of the playing terminal 100 being relatively small, the speed bar 102 being not long enough so that an accurate location along the speed bar can represent an accurate moment in the video program, the multimedia file being relatively large (X.XGB), or the video playing time being very long, etc., lead to inaccuracies. The inaccuracies may result in that the position indicated by a key or finger by the user along the speed bar would correspond to a time period, rather than to a moment or relatively accurate time or location in the video or audio program represented by the speed bar. Thus, it is hard precisely to allocate the playing speed to the preferred position, e.g., the position or location in the file intended to be specified or selected by a user, such as the case shown in FIG. 1A, where the playing speed usually may be allocated to the proximity of the T2 moment. For example, in the case shown in FIG. 1B, when the user wants to watch the video content from a T3 moment (00:12:00), which is relatively close to the T1 moment such that the icons T1 and T3 overlap, the T3 moment cannot be precisely allocated due to the above limitations.

The embodiments of the present invention provide a multimedia playing control method, playing control module and playing terminal, which may precisely allocate the playing speed to the preferred position, without being affected by the size of the display screen of the playing terminal, the size and playing time of the played multimedia file, the size of the speed bar, and the size of the playing window (playing mode) selected by the user.

According to one aspect of the embodiments of the present invention, there is provided a multimedia playing control method, including:

detecting a position indicated by a user on a speed bar displaying a playing speed of a multimedia file; and amplifying and displaying the time period to which the position corresponds by a

predetermined amplifying parameter, such that the user selects a playing moment according to the amplified and displayed time period.

The method further includes:

receiving an indication of a playing moment selected by the user according to the amplified and displayed time period;

determining, according the indication, the playing moment selected by the user according to the amplified and displayed time period; and

playing the multimedia file according to the selected playing moment.

The predetermined amplifying parameter is determined according to one or more pieces of the following information: the size of a displaying screen, the size and time of a played multimedia file, and a playing mode for playing the multimedia file.

Wherein, the position is indicated by using an operating part or a finger.

According to another aspect of the embodiments of the present invention, there is provided a multimedia playing control module, including:

a detecting unit, for detecting a position indicated by a user on a speed bar displaying a playing speed of a multimedia file; and

a first processing unit, for amplifying and displaying the time period to which the position corresponds by a predetermined amplifying parameter, such that the user selects a playing moment according to the amplified and displayed time period.

The module further includes:

a receiving unit, for receiving an indication of a playing moment selected by the user according to the amplified and displayed time period;

a determining unit, for determining, according the indication, the playing moment selected by the user according to the amplified and displayed time period; and

a second processing unit, for playing the multimedia file according to the selected playing moment.

Wherein, the predetermined amplifying parameter is determined according to one or more pieces of the following information: the size of a displaying screen, the size and time of a played multimedia file, and a playing mode for playing the multimedia file.

According to a further aspect of the embodiments of the present invention, there is provided a multimedia playing terminal, including the multimedia playing control module as stated above.

The playing terminal further includes: a displaying unit, for displaying an amplified time period.

The multimedia playing control method, playing control module and playing terminal may precisely allocate the playing speed to the preferred position by amplifying and displaying the time period of the position indicated by the user, without being affected by the size of the display screen of the playing terminal, the size and playing time of the played multimedia file, the size of the speed bar, and the playing mode, and solve the technical problems that existed in the prior art.

Many aspects of the invention can be better understood with reference to the following drawings. The components in the drawings are not necessarily to scale, emphasis instead being placed upon clearly illustrating the principles of the present invention. Elements and features depicted in one drawing or embodiment of the invention may be combined with elements and features depicted in one or more other drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. As will be appreciated, the drawings and the following description are merely some embodiments of the present invention, and to the ordinary technicians in the art, other drawings may be obtained according to these drawings, without making an inventive effort.

FIGS. 1A and 1B are schematic diagrams showing prior art speed allocation of played video content;

FIG. 2 is a flowchart of the multimedia playing control method of embodiment 1 of the present invention;

FIG. 3 is a flowchart of the multimedia playing control method of embodiment 2 of the present invention;

FIG. 4 is a schematic diagram of the structure of the multimedia playing control module of embodiment 3 of the present invention;

FIG. 5 is a schematic diagram of the structure of the multimedia playing control module of embodiment 4 of the present invention;

FIG. 6 is a schematic diagram of the structure of the playing terminal of embodiment 5 of the present invention;

FIG. 7 is a schematic diagram of the structure of the player of embodiment 5 of the present invention; and

FIGS. 8A-8E are schematic diagrams of playing control by the playing terminal of embodiment 6 of the present invention.

### DETAILED DESCRIPTION OF THE INVENTION

Particular embodiments of the present invention shall be described below with reference to the drawings. In the description below, details are given for the sake of interpretation, and not of limitation, for complete understanding of the present invention. However, it will be evident to those skilled in the art that the present invention may be carried out in other embodiments departing from these details.

It should be noted that in order that the present invention is not made obscure due to unnecessary details, structures of equipment and/or processing steps closely related to the technical solution of the present invention are only shown in the drawings, and other details less related to the present invention are omitted.

The term “playing terminal equipment” may include apparatuses having a function of playing multimedia audio/video files. For example, it may include terminal equipment having a function of playing multimedia audio and video files, such as a mobile terminal, a mobile phone, a computer, an MP3, an MP4, an electronic notebook, an electronic tablet, a personal digital assistant (PDA) or the like.

The preferred embodiments of the present invention are described as follows with reference to the drawings.

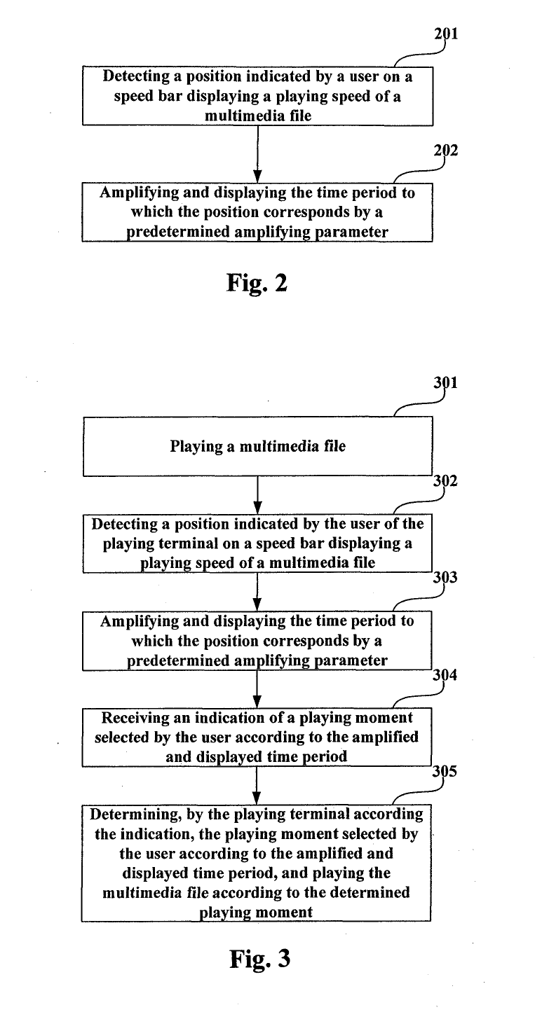

FIG. 2 illustrates a multimedia playing control method of embodiment 1 of the present invention. As shown in FIG. 2, the method includes the following steps:

Step 201: detecting a position indicated by a user on a speed bar displaying a playing speed of a multimedia file.

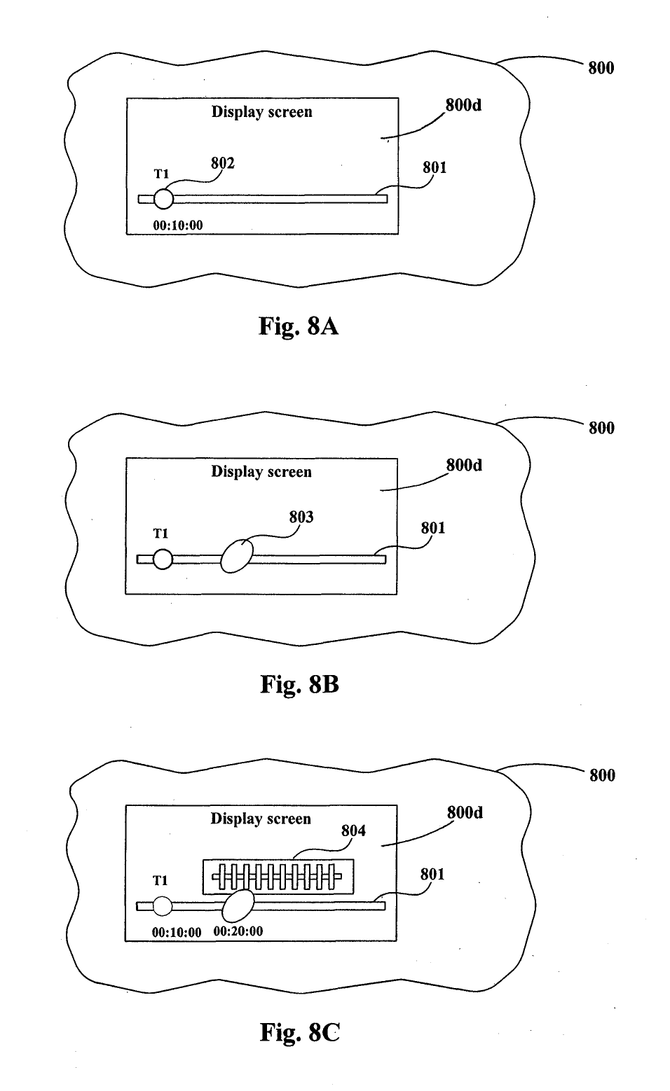

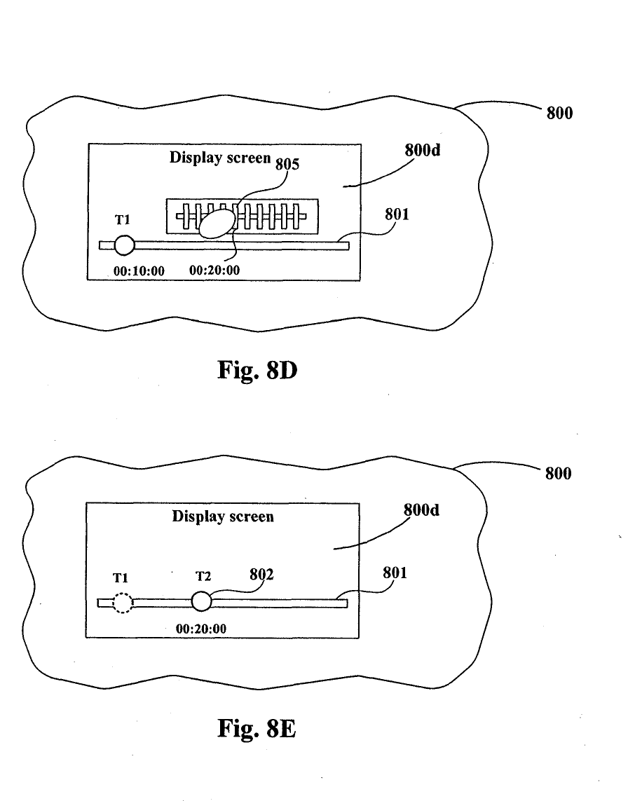

Step 202: amplifying and displaying the time period to which the position indicated by the user corresponds by a predetermined amplifying parameter, such that the user is able to select a playing moment according to the amplified and displayed time period. An example of amplifying and displaying such time period is described below with respect to the illustrations in FIGS. 8A-8E.

It can be seen from the above embodiment that the playing speed may be precisely allocated to the preferred position by amplifying and displaying the time period to which the position indicated by the user corresponds, without being affected by the size of the display screen of the playing terminal, the size and playing time of the played multimedia file, the size of the speed bar, and the playing mode, and the technical problems existed in the prior art are solved.

In this embodiment, the multimedia file includes video files and audio files.

In this embodiment, after the time period is amplified and displayed, the user may select a precise playing moment according to the amplified and displayed time period. Hence, the method may further include: receiving an indication of a playing moment selected by the user according to the amplified and displayed time period; determining, according the indication, the playing moment selected by the user according to the amplified and displayed time period; and playing the multimedia file according to the selected playing moment.

In this embodiment, the predetermined amplifying parameter may be randomly determined as actually required. For example, the predetermined amplifying parameter is determined according to one or more pieces of the following information: the size of a displaying screen, the size and time of a played multimedia file, and a playing mode for playing the multimedia file. For example, the playing mode for playing the multimedia file refers to the size of the playing window selected by the user, i.e. full screen playing or non-full screen playing.

In this embodiment, the amplifying parameter may be set as actually required. For example, when the size of the displaying screen is 3 inches, the amplifying parameter may be 10 minutes, that is, the time period of the position is correspondingly amplified and displayed as 10 minutes; when the size of the displaying screen is 6 inches, the amplifying parameter may be 5 minutes, that is, the time period of the position is correspondingly amplified and displayed as 5 minutes; and so on and so forth. Thus, the user may select the preferred playing moment according to the amplified and displayed time period. However, the above values are embodiments of the present invention only, the amplifying parameter is not limited thereto, and any other values may be set as actually required.

In this embodiment, when the playing terminal is a mobile terminal, the user may indicate the position by using a directional key of the mobile terminal, a finger, or an indication part (such as a touch screen). And when the playing terminal is a computer, the user may indicate the position by using a mouse.

FIG. 3 is the multimedia playing control method of embodiment 2 of the present invention. As shown in FIG. 3, the method includes the following steps:

Step 301: playing a multimedia file by the playing terminal having a function of playing audio/video files. The multimedia file may be an audio/video file. When the multimedia file is an audio file, the information of the audio file, such as the name, and the size, etc., may be displayed on the displaying screen of the playing terminal, and a speed bar indicating the playing speed of the audio file may also be displayed on the displaying screen. When the multimedia file is a video file, the video file may be displayed on the displaying screen of the playing terminal, and a speed bar indicating the playing speed of the video file may also be displayed on the displaying screen. As an example, the displaying screen may be a common liquid crystal screen or a touch screen.

Step 302: detecting a position indicated by the user of the playing terminal on a speed bar displaying a playing speed of a multimedia file.

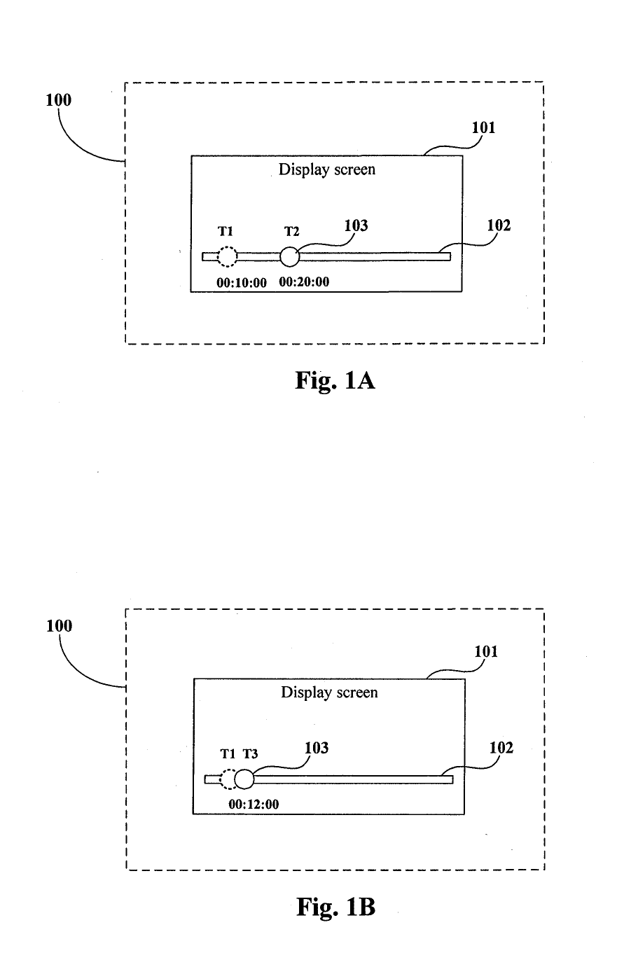

In this embodiment, as shown in FIG. 1A, when the current playing moment is T1, if the user hopes to skip over the multimedia content between T1 and T2 and listen to or watch the multimedia file starting from the T2 moment, the user may slide a finger or a mouse on the speed bar. Reference to sliding a mouse on the speed bar means sliding a mouse or like device such that a cursor is moved or slid as shown on the display. In carrying out the sliding of a finger on the speed bar, the finger may actually touch a touch sensitive display screen on which the speed bar is shown. Alternatively, an air touch sensing mechanism or configuration may be used such that the finger may be slid along the speed bar while in spaced-apart relation to the display on which the speed bar is shown; and the air touch sensing mechanism or configuration would sense finger location and sliding-type movement. When the finger or mouse is placed at a certain position on the speed bar (or adjacent the speed bar if an air touch mechanism or configuration is used), a corresponding playing moment is displayed on the position (this is similar to the prior art, and shall not be described any further). Thus, reference to sliding includes both the possibility of actually touching the display or being in air touch spaced relation to the display. In this way, the user may select the desired playing moment according to the displayed playing moment; and when the user places the finger or mouse at a certain position on the speed bar, the playing terminal may detect the position indicated by the user, the position corresponding to the desired playing moment of the user;

Step 303: amplifying and displaying, by the playing terminal, the time period to which the position corresponds by a predetermined amplifying parameter.

In the prior art, the user may not precisely indicate the T2 moment by a finger or a mouse, and may usually indicate a time period including the T2 moment. Hence, a problem that the playing moment cannot be precisely selected exists in the prior art.

However, in this embodiment, the user may precisely select a desired playing moment by amplifying and displaying the time period to which the position corresponds.

The predetermined amplifying parameter may be randomly determined as actually required. For example, the predetermined amplifying parameter is determined according to one or more pieces of the following information: the size of a displaying screen, the size and time of a played multimedia file, and a playing mode for playing the multimedia file.

For example, when the amplifying parameter is 5 minutes, the time period of the position may be correspondingly amplified and displayed as 5 minutes. Thus, the user may select the preferred playing moment according to the amplified and displayed time period.

Step 304: receiving an indication of a playing moment selected by the user according to the amplified and displayed time period.

In this embodiment, after the time period is amplified and displayed by the playing terminal, the user may select a desired moment on the amplified time period by pressing with a finger or clicking with a mouse. Hence, the playing terminal may receive the indication from the user.

Step 305: determining, by the playing terminal according the indication, the playing moment selected by the user according to the amplified and displayed time period, and playing the multimedia file according to the determined playing moment.

It can be seen from the above embodiment that the playing speed may be precisely allocated to the preferred position by amplifying and displaying the time period to which the position indicated by the user corresponds, without being affected by the size of the display screen of the playing terminal, the size and playing time of the played multimedia file, and the size of the speed bar, and the technical problems existed in the prior art are solved.

The above flowcharts are illustrative and explanatory only, the method according to the embodiments of the present invention does not necessarily require each of the above steps, and some of the steps may be deleted, combined or reversed. The method of the embodiments of the present invention is not limited to being carried out in the temporal orders as explained in the description, and may be carried out in other temporal orders, parallelly, or independently. All the variants should be covered by the scope of the present invention so long as they do not depart from the spirits and scope of the claims of the present invention.

The embodiments of the present invention further provide a playing control module and a playing terminal as described further below. As the principles of solving problems of the playing control module and playing terminal are similar to those of the playing control method of the above embodiments, the implementation of the method may be referred to in the implementation of the playing control module and playing terminal, and the repeated parts shall not be described any further.

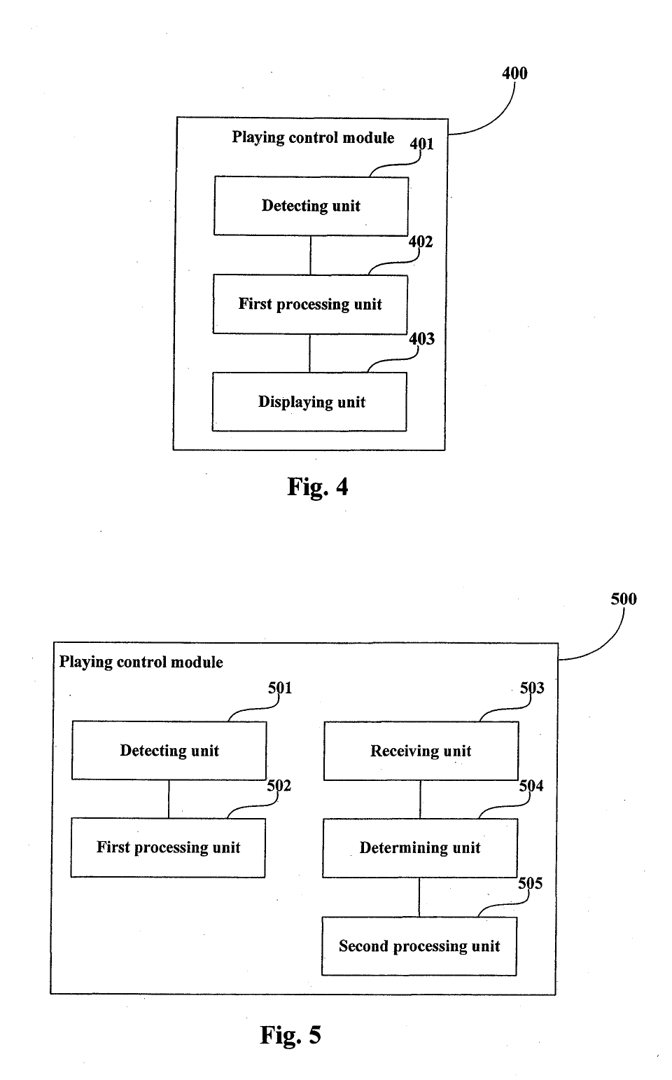

FIG. 4 is a schematic diagram of the structure of the playing control module 400 of embodiment 3 of the present invention. The playing control module may be applicable to a playing terminal having a function of playing multimedia files. As shown in FIG. 4, the playing control module includes: a detecting unit 401, a first processing unit 402, and a displaying unit 403, e.g., including a display screen.

The detecting unit 401 is used for detecting a position indicated by a user on a speed bar displaying a playing speed of a multimedia file. The first processing unit 402 is used for amplifying and displaying the time period to which the position corresponds by a predetermined amplifying parameter, such that the user selects a playing moment according to the amplified and displayed time period.

In this embodiment, the amplified and displayed time period may be displayed on the displaying screen of the playing terminal.

In this embodiment, the predetermined amplifying parameter is determined according to one or more of the following information: the size of a displaying screen, the size and time of a played multimedia file, and a playing mode for playing the multimedia file.

It can be seen from the above embodiment that the processing unit 402 may amplify and display the time period to which the position indicated by the user corresponds through detecting the position indicated by the user by the detecting unit 401, such that the user may precisely allocate the playing speed to the preferred position, without being affected by the size of the display screen of the playing terminal, the size and playing time of the played multimedia file, the size of the speed bar, and the playing mode, and the technical problems existed in the prior art are solved.

FIG. 5 is a schematic diagram of the structure of a multimedia playing control module 500 of embodiment 4 of the present invention. The playing control module 500 may be applicable to a playing terminal having a function of playing multimedia files. As shown in FIG. 5, the playing control module 500 includes a detecting unit 501 and a first processing unit 502, the functions of which being similar to those of embodiment 3, which shall not be described any further.

As shown in FIG. 5, the multimedia playing control module 500 further includes a receiving unit 503, a determining unit 504 and a second processing unit 505. The receiving unit 503 is used for receiving an indication of a playing moment selected by the user according to the amplified and displayed time period. The determining unit 504 is used for determining, according the indication, the playing moment selected by the user according to the amplified and displayed time period. The second processing unit 505 is used for playing the multimedia file according to the selected playing moment.

It can be seen that the first processing unit 502 may amplify and display the time period of the position indicated by the user through detecting the position indicated by the user by the detecting unit 501, determine the playing moment selected by the user after receiving the indication inputted by the user, and plays the multimedia file according to the playing moment.

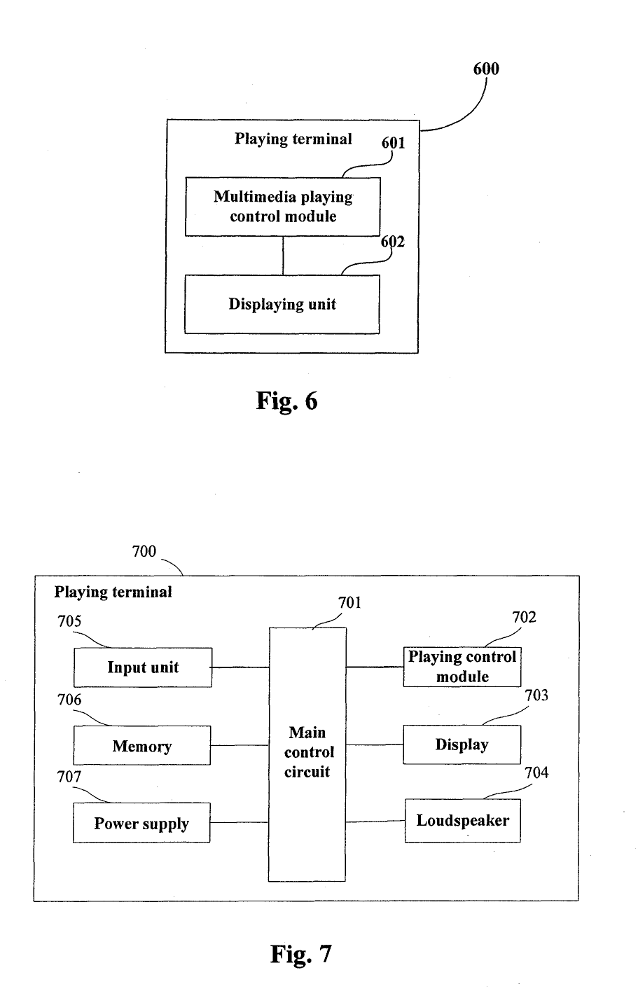

FIG. 6 is a schematic diagram of the structure of a playing terminal 600 of embodiment 5 of the present invention. As shown in FIG. 6, the playing terminal 600 includes the multimedia playing control module 601 of embodiment 4 or 5, with the functions of the multimedia playing control module 601 being similar to those of the above, which shall not be described any further.

Furthermore, as shown in FIG. 6, the playing terminal 600 includes a displaying unit 602 for displaying the multimedia file, the playing speed of the multimedia file and the amplified time period.

In the above embodiment, the playing terminal 600 may be various terminal equipment having a function of playing multimedia files, such as a mobile terminal, a mobile phone, an MP3, an MP4, a computer, a PDA, etc.

For example, the playing terminal may be an MP3 player or an MP4 player. As shown in FIG. 7, the player 700 includes a main control circuit 701, a playing control module 702, a display 703, a loudspeaker 704, an input unit 705, a memory 706, and a power supply 707.

The main control circuit 701 may sometimes be referred to as a controller or an operating control, which includes a microprocessor or other processor devices and/or logic device(s). The main control circuit 701 receives input and controls the operations of each of the components of the player 700. In this embodiment, a multimedia file stored in the memory 706 may be played according to the instructions inputted by the user, namely, the image of the video file may be displayed on the display 703 and the audio signal of the video file may be played via the loudspeaker 704, or an audio file may be played via the loudspeaker 704.

The playing control module 702 may control the playing speed of the multimedia file displayed on the display 703, with its composition and functions being similar to those of embodiments 3 and 4, which shall not be described any further. The playing control module 702 may be configured independently and controlled via the main control circuit 701; and it may also be combined with the main control circuit 701 as a part of the latter.

The display 703 may be, for example, an LCD display or a touch screen; however, it is not limited thereto. In this embodiment, the display 703 may display the multimedia video file extracted from the memory 706 and play the playing speed of the multimedia video file under the control of the main control circuit 701; furthermore, it amplifies and displays the time period to which a position selected by the user corresponds when the user has selected the position on the speed bar.

The loudspeaker 704 plays an audio file stored in the memory 706 and plays the audio signal of a video file under the control of the main control circuit 701.

The input unit 705 provides various user input operations. For example, the input unit 705 usually includes functional keys, such as the keys controlling the fast forward, fast backward, playing, pause, stop, recording, and volume, of the playing. Furthermore, the input unit 705 may include directional keys for the user to select the positions on the speed bar (corresponding to the playing moments), and a confirmation key for confirming a selected playing moment. When the display 703 is a touch screen, the input unit 705 may be an indication part (such as a writing pen); and when the display screen is a touch screen, the indication part may be optional.

The memory 706 may be, for example, used for storing application programs and function programs, or for storing the operational procedures to be executed by the main control circuit 701, and it may further be used for storing multimedia files and predetermined amplifying parameters.

The power supply 707 is used for supplying electric power.

The components of the playing terminal 700 may be implemented by specific hardware, firmware, software, or a combination thereof, without departing from the scope of the present invention.

The above embodiment is described taking a player as an example. Furthermore, the playing terminal may be a mobile phone having a function of playing a multimedia file. If it is a mobile phone, the mobile phone may further include, besides those components shown in FIG. 7, a communication part having a function of receiving and transmitting, and an antenna, etc. The input unit 705 further has alphanumeric keys, and one or more special function keys, such as a “call sending” key for initiating or responding a call, and a “call ending” key for ending or “hanging up” a call, etc., which are similar to those of the prior art, which shall not be described any further.

For example, the playing terminal may be a computer. The user may select a position on the speed bar via a mouse, and the computer operates a display to display an amplified time period on the display. The user sends instructions to the computer via the mouse, such that the playing terminal, e.g., the computer, determines the playing moment that the user desires, which is similar to other mobile terminals, and shall not be described any further.

FIGS. 8A-8E are schematic diagrams illustrating an example of playing control by the playing terminal of embodiment 6 of the present invention. The following description is given taking the playing terminal shown in FIG. 5 as an example, wherein the displaying unit is a touch screen.

As shown in FIG. 8A, the playing terminal 800 having a function of playing audio/video files plays a multimedia file. For example, the multimedia file may be a video file, the image of which may be displayed on the display screen 800d of the playing terminal. A speed bar 801 indicating the playing speed of the video file also may be displayed on the display screen. The display screen may be a common liquid crystal screen or a touch screen, and in this embodiment, it is a touch screen.

If the current playing moment is T1 (00:10:00, e.g., ten minutes into the playing of the multimedia file) and the user wants to skip over T1-T2 (00:20:00), e.g., skipping the content from 00:10:00 to 00:20:00, the user may slide his finger or an indication part 803 (such as a writing pen) on the speed bar 801, and all the passed positions will display the times (i.e. the playing moments) to which the positions correspond. The user may place the finger or the indication part on a corresponding position on the speed bar according to the displayed time, as shown in FIG. 8B. At this time, the playing terminal detects the position indicated by the user on the speed bar.

Being affected by the above, the user cannot precisely select a corresponding position (corresponding to the moment T2), but rather can select a time period including the moment to which the position corresponds. Hence, the playing terminal 800 amplifies and displays the time period. As shown in FIG. 8C, the playing terminal amplifies and displays the time period to which the position corresponds by a predetermined amplifying parameter. As shown in FIG. 8C, an amplified time period 804 is displayed on the display screen. For example, the amplifying parameter is 10 minutes, and a time of 10 minutes including T2 may be displayed, such as a time period from 00:16:00 to 00:25:00.

The user may select a corresponding moment, i.e. T2 (00:20:00), according to the amplified and displayed time period 804, and the user may select the corresponding moment by pressing at 805 the selected position with a finger or an indication part, as shown in FIG. 8D. At this time, the playing apparatus receives an indication of a playing moment selected by the user according to the amplified and displayed time period, determines, according to the indication, the playing moment selected by the user according to the amplified and displayed time period, and plays the multimedia file according to the determined playing moment. In this way, the terminal equipment plays the multimedia file from the T2 moment, as shown in FIG. 8E.

In addition, the similar method may be used in the case shown in FIG. 1B and the case where the multimedia file is played back, which shall not be described any further.

In the above embodiment, if the terminal equipment is a computer, the user may select a corresponding moment by sliding the mouse on the speed bar, and may determine the selected playing moment using the mouse after the corresponding time period is amplified and displayed.

The amplifying parameter may be set as actually required, and may be a random value.

It can be seen from the above embodiment that the playing terminal may amplify and display the time period to which the position indicated by the user corresponds through detecting the position indicated by the user by the detecting unit, determine the playing moment selected by the user after receiving the indication inputted by the user, and play the multimedia file according to the playing moment. In this way, the playing moment may be precisely selected, and the technical problems existed in the prior art are solved.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The above apparatus and methods may be carried out in hardware, and cal also be carried in a combination of hardware and software. The present invention relates to such a computer-readable program that when the program is executed by a logic component, the logic component may be enabled to carry out the apparatus or constitutional components as described above, or the logic component is be enabled to carry out the methods or steps as described above. The present invention relates also to a storage medium storing the above program, such a hard disc, a floppy disc, a compact disc, a DVD, or a flash memory, etc.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A multimedia playing control method, comprising:
detecting a position indicated by a user on a speed bar displaying a playing speed of a multimedia file; and
amplifying and displaying the time period to which the position corresponds by a predetermined amplifying parameter to provide for selecting by a user a playing moment according to the amplified and displayed time period.

2. The method according claim 1, wherein the method further comprises:
receiving an indication of a playing moment selected by the user according to the amplified and displayed time period;
determining, according the indication, the playing moment selected by the user according to the amplified and displayed time period; and
playing the multimedia file according to the selected playing moment.

3. The method according claim 1, wherein the predetermined amplifying parameter is determined according to one or more pieces of the following information: the size of a displaying screen, the size and time of a played multimedia file, and a playing mode for playing the multimedia file.

4. The method according claim 1, wherein the position is indicated by using an operating part or a finger.

5. A multimedia playing control module, comprising:
a detecting unit configured to detect a position indicated by a user on a speed bar displaying a playing speed of a multimedia file; and
a first processing unit configured to amplify and display the time period to which the position corresponds by a predetermined amplifying parameter to provide for selecting by the user a playing moment according to the amplified and displayed time period.

6. The module according claim 5, wherein the module further comprises:
a receiving unit configured to receive an indication of a playing moment selected by the user according to the amplified and displayed time period;
a determining unit configured to determine, according the indication, the playing moment selected by the user according to the amplified and displayed time period; and
a second processing unit configured to play the multimedia file according to the selected playing moment.

7. The module according claim 5, wherein the predetermined amplifying parameter is determined according to one or more pieces of the following information: the size of a displaying screen, the size and time of a played multimedia file, and a playing mode for playing the multimedia file.

8. A multimedia playing terminal, comprising the multimedia playing control module as claimed in claim 5.

9. The playing terminal according to claim 8, further comprising:
a displaying unit, for displaying the multimedia file, a playing speed of the multimedia file and an amplified time period.

10. The method according claim 2, wherein the predetermined amplifying parameter is determined according to one or more pieces of the following information: the size of a displaying screen, the size and time of a played multimedia file, and a playing mode for playing the multimedia file.

11. The method according claim 2, wherein the position is indicated by using an operating part or a finger.

12. The module according claim 6, wherein the predetermined amplifying parameter is determined according to one or more pieces of the following information: the size of a displaying screen, the size and time of a played multimedia file, and a playing mode for playing the multimedia file.

13. A multimedia playing terminal, comprising the multimedia playing control module as claimed in claim 6.

14. A multimedia playing terminal, comprising the multimedia playing control module as claimed in claim 7.
